(19) United States
(12) Patent Application Publication
(10) Pub. No.: US 2010/0153377 A1
(43) Pub. Date: Jun. 17, 2010

(54) SYSTEM AND METHOD FOR ENHANCED AUTOMATION OF INFORMATION TECHNOLOGY MANAGEMENT

(76) Inventors: Palaniswamy Rajan, Atlanta, GA (US); Purushottaman Nandakumar, Atlanta, GA (US); James DeLuccia, IV, Atlanta, GA (US); Karunakaran Rajasekharan, Atlanta, GA (US)

Correspondence Address: Hill, Kertscher & Wharton, LLP, 3350 Riverwood Parkway, Suite 800, Atlanta, GA, 30339, US

(21) Appl. No.: 12/636,279

(22) Filed: Dec. 11, 2009

Related U.S. Application Data
(60) Provisional application No. 61/201,671, filed on Dec. 12, 2008.

(51) Int. Cl. G06F 17/30

(52) U.S. Cl. 707/723; 707/769; 707/802; 707/E17.014; 707/E17.044

(57) ABSTRACT

A system and method of managing enterprise information technology systems using autonomic social computing is described herein. The system comprises a configuration management database containing not only configuration parameters relating to individual components within the system, but also data regarding relationships between these components. This data is compiled and monitored using a correlation engine, a confidence engine, and a social discovery engine working in conjunction with each other to maintain threshold performance parameters set by management personnel. Configuration management reports for IT management personnel are also generated by the system.

### CROSS REFERENCE TO RELATED APPLICATIONS

This application claims priority to Application Ser. No. 61/201,671, filed Dec. 12, 2008.

### BACKGROUND OF THE INVENTION

The field of the invention is information technology (IT) management automation. Management of IT in enterprise organizations is becoming increasingly complex and untenable due to the large number of IT assets multiplied by the number of interactions and configurable parameters involved. The IT systems of such organizations are sometimes referred to as an “ecosystem”, because IT is no longer a stand-alone function of the organization. The ecosystem concept encompasses both the physical and logical aspects of the assets of an IT organization; both must be managed. Because of the ubiquity of IT in the operating models and operations of most businesses today, there are a number of stakeholders within this ecosystem, including consumers (the end users of the information technology system, whether they are customers or employees), producers (including vendors of both product and service technologies), influencers (management and other stakeholders of the business who have increasingly greater influence over IT management), and administrators of the systems. The overall goal of IT management is to ensure that the IT ecosystem is aligned with the business needs of the enterprise.

Enterprise IT management within such an ecosystem is often painfully fragmented and ad hoc. This is due in part to a lack of records relating to the entire system's configuration and the lack of a systematic method of managing the IT assets of an organization. The problems are compounded by the relative lack of trained personnel available who are able to manage large-scale IT infrastructures. The sheer number of assets in an enterprise IT system, multiplied by the number of parameters required to optimize each asset makes the maintenance of configuration records and the lack of a systematic method of management an enormous problem. Compounding the problem is the requirement of enterprise IT systems to comply with one and sometimes multiple layers of regulatory obligations. For instance, enterprise IT systems are required to comply with accounting and data security policies that may be imposed by external laws and regulations, such as Sarbanes-Oxley, Graham-Leach-Bliley, Payment Card Industry (PCI), accounting best practices, FASB and SEC rules. Enterprise IT systems are also subject to the internal policies of the company, such as security policies as well as adoption of best practice standards and frameworks like ITIL v3, IS027001, IS017799, etc.

Finally, the IT assets of the organization ultimately must serve the business goals of the enterprise. One difficulty faced by IT managers is that differing persons within the organization are formed into workgroups, which may extend across organizational units, as shown in FIG. 1. The problems in managing the enterprise IT system are also compounded by the need to serve individual consumers within the organization, each of whom may have vastly differing requirements to be served by the IT system. All of this presents a monumental challenge for IT managers, and key stakeholders (i.e. the CIO/CTO, Business Users) in the management hierarchy who need to monitor the overall functioning and health of the enterprise IT system.

Currently, IT operational managers and personnel rely largely on personal interaction, ad hoc configuration records kept in Excel® spreadsheets, and multiple un-integrated point solutions to manage enterprise IT. Managing enterprise IT in this fashion results in a lack of ability to clearly see IT assets, threats, vulnerabilities, and business impact of IT configuration changes. In particular, decision makers for the enterprise IT system lack the ability to determine which processes and assets need to be protected and how they should be protected. They also lack the ability to leverage and integrate policies for one part of the system with those in another part of the system.

Finally, managers and operational personnel lack the ability to answer enterprise IT ecosystem management questions in near real-time. Examples of these questions include: What is the enterprise inventory of servers? Of databases? Of applications? What applications depend upon a particular database? What software, databases, and servers are critical to the production of a particular product or the provision of a particular service? Which business processes use a particular application? Executive management persons are increasingly demanding answers to these questions. They are also concerned with the business' true risk exposure due to the enterprise IT system, its current operational maturity and efficiency level, and how to implement plans to optimize risk levels to predetermined targets.

There is therefore a great need to give executive managers and IT managers near real-time dashboards containing business metrics and actionable analytics. Such a dashboard would facilitate faster adoption and leveraging of industry-standard frameworks such as ITIL v3 or ISO 27001. It would also help to integrate IT-related decisions into the overall business decision making process, facilitating proactive decision making and improving response time to changes in the business environment. It would also eliminate information “silos”, and create an environment where data is readily available across organizational boundaries to all relevant members who need to use, or would benefit from, such information. The result of all this is to increase the efficiency and effectiveness of IT employees.

### BRIEF SUMMARY OF THE INVENTION

An IT Business Operations Automation (IT-BOA) system is a platform or application suite enabling organizations to dramatically improve their IT business alignment, performance, and governance, as shown in FIG. 2. It provides visibility and automation by integrating real-time monitoring, Web 2.0 concepts, autonomic computing, social computing, and business analytics. The objectives of the system include: gathering of IT ecosystem data, visualization of relevant entities, mapping of key relationships within the IT management organization, monitoring the health of the system, efficiency in updating and maintaining an ecosystem management database (EMDB), and the derivation and application of actionable intelligence. The organization's EMDB can be standalone or federated. The EMDB is created and updated using an integration of autonomic computing and social computing interfaces. The integration of the two may be referred to as “autonomic social computing”. Thereafter the EMDB is managed by an intelligent correlation engine which determines current quality of system configuration data, identifies the appropriate user who has the information needed to improve the quality of system configuration data, and which contains an intelligent agent that both generates human interface conversation and aggregates and reconciles human input data. Thus, a number of autonomic social computing engines work together for data reconciliation and consistency in an IT management environment to ensure that the IT system serves the business goals of the organization. This autonomic social computing paradigm facilitates the management and execution of policies for the entire IT ecosystem.

### BRIEF DESCRIPTION OF THE DRAWINGS

FIG. 1 shows how the traditional structure of IT management is organized into “silos” and ignores the fact that business process workgroups conflict with this traditional structure.

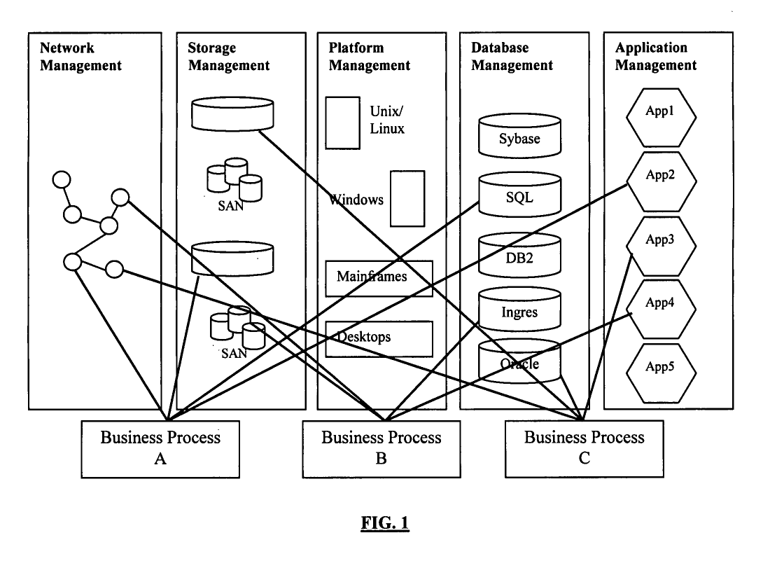

FIG. 2 is a process diagram of the IT Business Operations Automation system.

FIG. 3 shows the subsidiary components of the ecosystem management database (EMDB).

FIG. 4 shows the processing flow of data into the correlation engine.

FIG. 5 is a flowchart showing the general heuristic used by the system in updating and maintaining high confidence values.

FIG. 6 is a functional block diagram of the system.

FIG. 7 shows the data transformation and data loading functions in relation to the confidence and social discovery engines, and the EMDB.

FIG. 8 is a flowchart of a process used to calculate confidence values for entities in the IT ecosystem.

FIG. 9 shows the social discovery engine in detail and shows the overall user query process.

FIG. 10 is a flow diagram of the system supporting an auditing process.

FIG. 11 shows the user input interface.

FIG. 12 shows the user report interface dashboard.

### DETAILED DESCRIPTION OF THE INVENTION

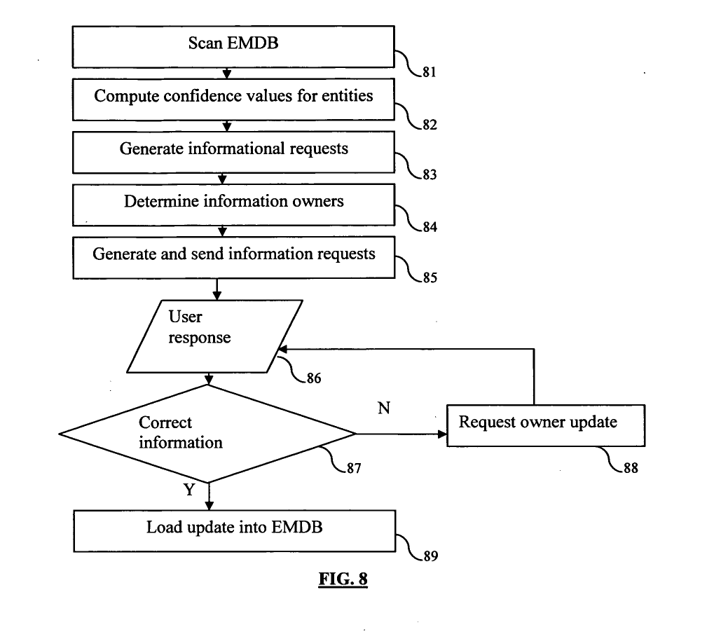

The system described herein consists of four primary components, as shown in FIG. 6: an ecosystem management database (EMDB), a correlation engine, a confidence engine, and a social discovery engine. The system extracts and monitors data from diverse IT management applications and databases such as, but not limited to, system management tools, security management tools, network management tools, network infrastructure, physical infrastructure, as well as documents relating to the various assets and business processes. It also extracts data from trusted and untrusted data sources (such as flat files, databases, or end-user web applications) through multiple interfaces that are well known in the art.

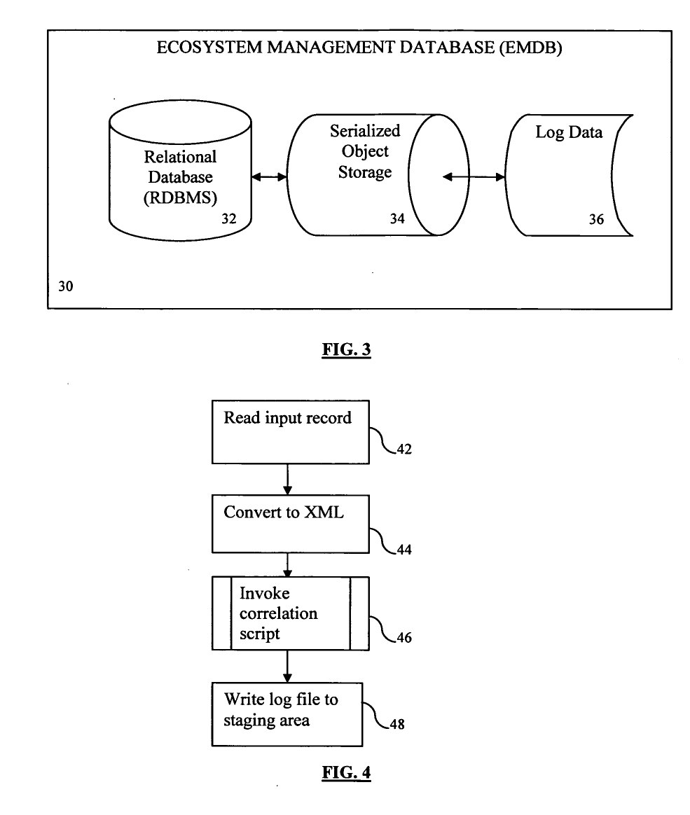

All configuration and relationship data is stored in an Ecosystem Management Database (EMDB) 30, as shown in FIG. 3. The EMDB contains information about all IT systems, processes, users, and documents (including contracts) that influence an organization's IT systems, in addition to the interactions and interrelationships between these and their behaviors. The EMDB not only contains configuration data on all entities within an organization's IT system like a conventional configuration management database (CMDB), it also contains data on the relationships among these entities, allowing decision support queries to be executed in support of organizational IT policies and operational goals. It also stores time series data including fully logged historical data which gives IT personnel the ability to undo and redo IT system configuration changes.

As shown in FIG. 3, the EMDB consists of three separate datastores: a relational database 32, an unstructured/serialized object storage 34, and log data 36. Relational database 32 stores reference data about entities, relationship data between entities, ecosystem hierarchical data, and time series data for reporting and analysis purposes. Unstructured/serialized datastore 34 contains entity data in serialized form and unstructured data such as documents in serialized plain text as well as original form. Log data file 36 stores transaction data reflecting changes in the entities. Each transaction for an entity is stored in a separate log file. As shown in FIG. 6, incoming log files are stored sequentially in a staging zone 64 where they are processed sequentially, where the relational database 32 and the unstructured data stores 34 are updated. Processed log files are transferred to a long term storage zone, where they are organized by entity, date, and time.

The term “entity” used herein can refer to a number of different things in the IT ecosystem. First, “entity” may refer to computer hardware, such as servers, workstations, desktops, and laptops. Second, “entity” may refer to virtual computer entities such as virtual machines, cloud instances, applications such as database servers, CRM, ERP, mail servers, and web servers. Third, “entity” may refer to network equipment such as routers, switches, and firewalls. Fourth, “entity” may refer to assets such as datacenters, datacenter rooms, and server racks. Finally, “entity” may refer to a process, user, an action or task, a workflow process, a document, or vendor information.

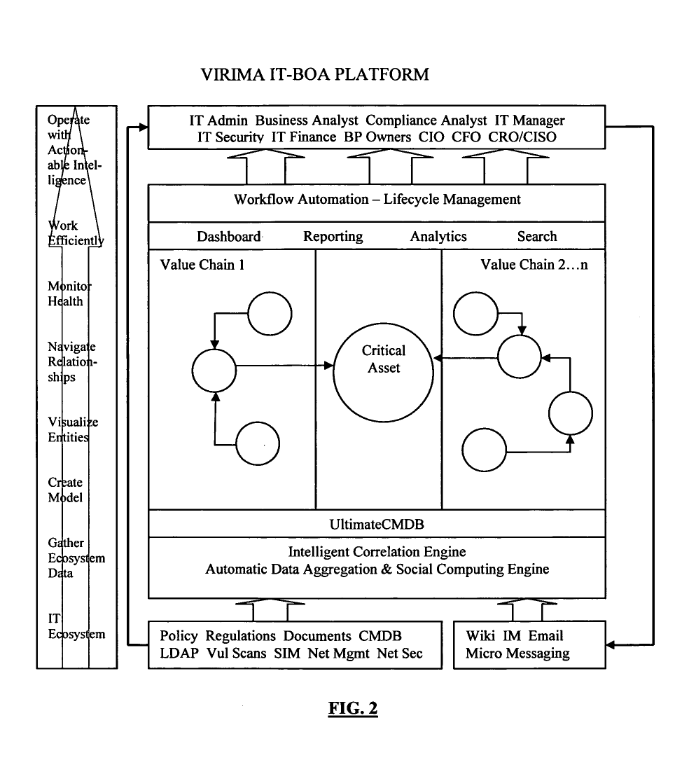

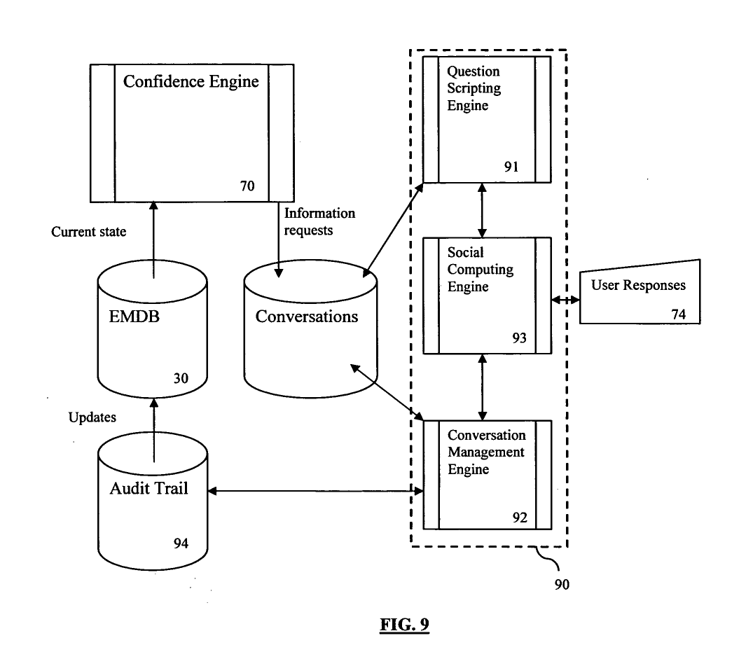

Referring to FIG. 7, the system initially federates entity data from multiple sources into the EMDB though a process of data transformation 71 using a data loader 72 that uses industry-standard processes such as ETL (extract-transform-load) within the IT infrastructure of an organization and generates entity records and informational records about the entities and information represented by the federated data. This process of federating data (referred to in FIG. 2 as “gather ecosystem data”) allows the system to initially populate the EMDB with the system assets. The initial discovery process may be done using active scans using a network mapping tool such as NMAP or the social computing techniques described herein. Initial discovery may also occur passively using logfiles or by scanning/importing from an existing (i.e. legacy) CMDB. The system then computes multiple metrics about the quality, consistency, and reliability of the entities and informational records generated from these active and passive scans.

EMDB 30, unlike conventional CMDBs, stores data about not only entities, but also stores data on the relationships between entities. The entity relationship data allows IT managers to model the overall IT ecosystem by showing how each entity is dependent upon, and interconnected to, other entities.

In addition to storing data on entities and the relationships between them, the EMDB also contains time series data about entities. Thus, historical configuration data about the changing properties of an entity, or the relationships between entities, can be shown. Examples of such historical data include utilization, availability, number of events, and security vulnerabilities. Thus, the EMDB is configured to support fully customizable entities, complex relationships among these entities, and time series data including a fully-logged historical configuration data allowing IT managers the ability to undo and redo system-wide configuration changes quickly.

The second primary component of the system is the correlation engine 62, shown in FIGS. 6 and 7. The correlation engine processes, aggregates, and reconciles incoming data from various input streams, including data from the confidence engine and social discovery engines. The correlation engine then creates new entity records, entity relationships, updates entity records, and writes output to the staging log store. Correlation engine 62 interfaces with social discovery engine (SDE) 90 and confidence engine 70 described below to map out relationships between entities. Initial configuration of the correlation engine involves loading blueprints and user-defined scripted functions.

Blueprints are flexible data structures or schemas describing an entity or relationship. Thus, a blueprint determines the various properties of an entity, including links between the entity and other entities within the system. Further, each property or link may possess properties or links of their own. For example, the property “vendor” may have, for a particular server, the value “ABC, Inc.”. The value “ABC, Inc.” itself may have additional attributes of “confidence”, “accuracy”, “age”, “last updated by”, and so on.

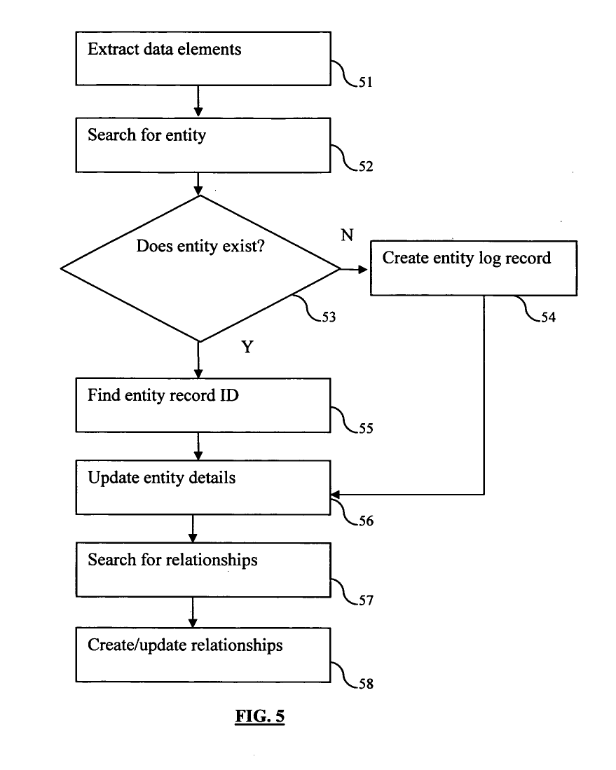

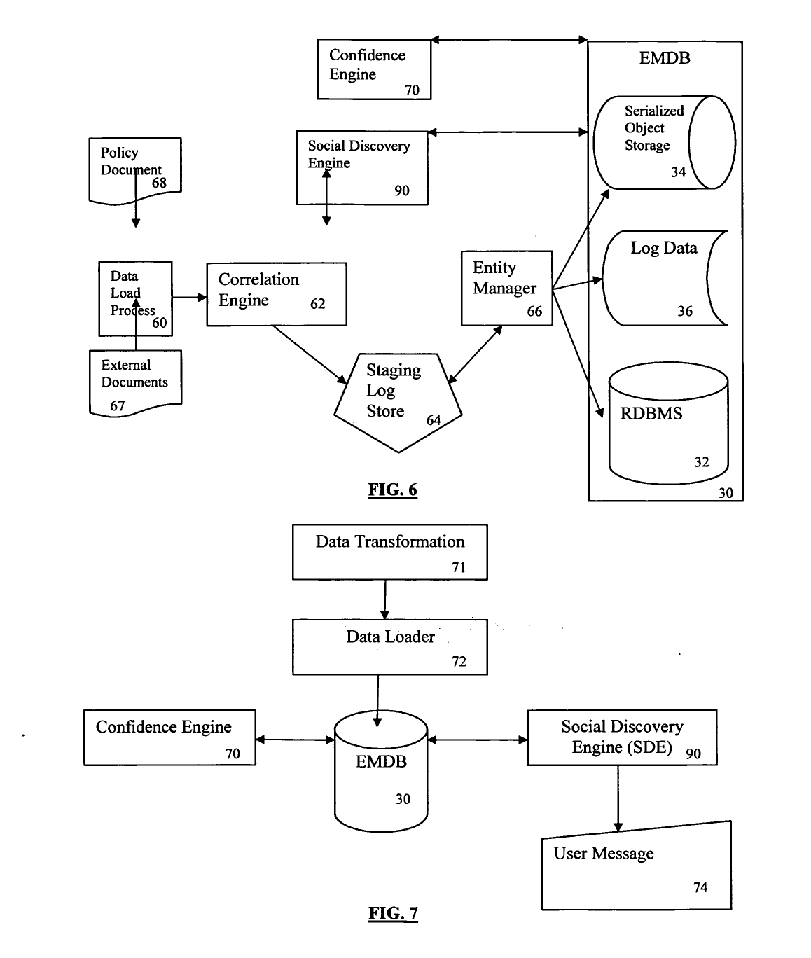

Referring now to FIGS. 4 and 5, the correlation engine reads each input data records 42. Each data record is then normalized to XML format 44. Correlation script is then invoked 46. In FIG. 5, a flowchart of this script, the correlation engine extracts the XML data record 51 and searches for an entity corresponding to this record 52. If the entity does not exist 53, a new entity log record is created 54 and entity details are updated with the data contained in the data record, 55. If the entity exists, 53, then the entity record ID is located and the entity details are updated with the data contained in the data record 55. Finally, the correlation engine searches 57 and updates relationship between entities 58, if the nature of the data indicates that such an update is appropriate.

FIG. 6 shows the flow of data through the correlation engine 62. Upon completion of the correlation script the output log file is written to the staging log store 64. The EMDB is then updated with the data by the entity manager 66. This two-step process, writing the data from the correlation engine to the staging log store 64 and then having entity manager 66 update the EMDB, is used for reasons of scalability and performance.

The third primary component, the confidence engine 70, shown in FIGS. 6 and 7, scans the EMDB periodically, computes confidence values for each entity, presents this confidence value along with other data to end users, improves data quality, and is able to present actionable intelligence to IT management. Actionable intelligence is information allowing IT managers to be proactive in making decisions regarding entities and assets affecting the performance of the IT ecosystem. In order to provide such actionable intelligence, the system needs to know what is happening, what the organization's goals are, and is able to use the information on what is happening (i.e. intelligence) to recommend a course of action to decision makers. Actionable intelligence allows decision makers to choose a course of action which will optimize the configuration of the IT ecosystem to meet the business goals of the organization. The confidence engine can be fully user-directed, where the confidence computation algorithms are completely specified by the user. Alternatively, confidence engine 70 can use general directions or rules, and infer the remaining computation mechanisms.

The confidence value generated by confidence engine 70 reflects the completeness, correctness, importance, and time value of the entity data stored in the EMDB. The confidence value is important because the utility of configuration data in the EMDB rapidly declines with a decline in the confidence of such information. However, because there is cost involved in collecting updated information, it is important to have an automated confidence calculation mechanism which reflects the real-life perception of the users.

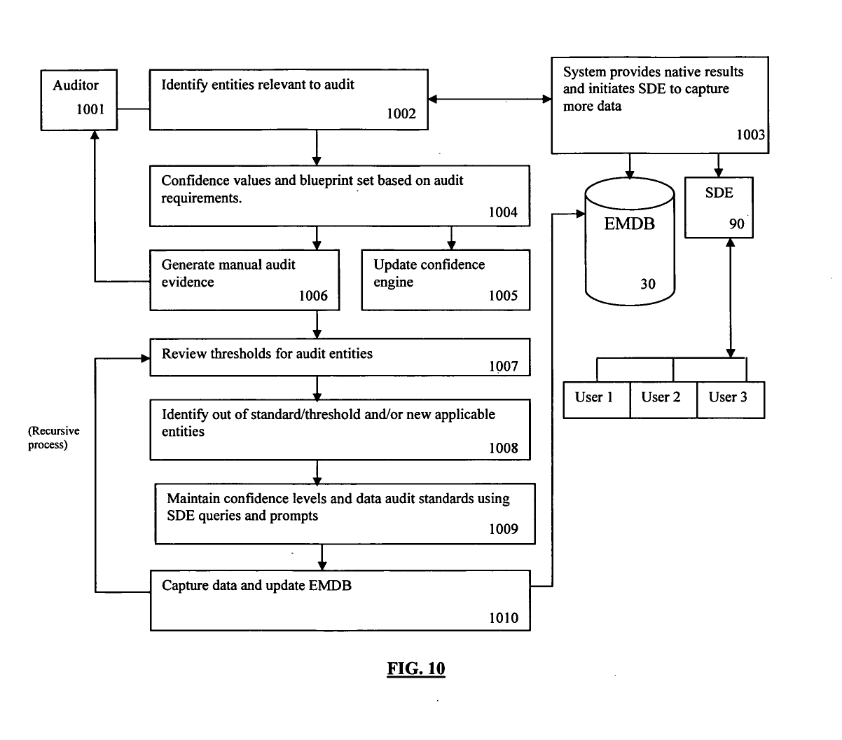

FIG. 8 shows how confidence values are generated by the confidence engine. Confidence engine 70 first scans the entire set of entities contained in the EMDB on a pre-defined time period 81. Confidence values are computed for each entity 82 based on a number of factors, such as: (a) type and basic characteristics of the asset; (b) the configuration properties of the asset; (c) key business impact properties of the asset; (d) age of the information; (e) frequency of use of the information; and (f) importance of the value chain that the asset supports. Other important factors contributing to confidence is whether the information about the asset from multiple sources is consistent or has been corroborated. Finally confidence may depend on whether there have been specific requests for information about a particular asset. Thus, for each entity, a confidence value is computed using heuristic algorithms and stored in the EMDB as a property of the entity. An example of such an algorithm follows:

```
For Each Entity
Set Confidence Value to ZERO
    Get list of Entity Property Weights (confidence factors)
    For each property with a Weight factor
        Get Property Value
        If Value Exists
            Add Weight to Confidence value
            Get time value was last updated
            If time older than <age factor>
                Decrement Confidence Value
    Goto next property
    Normalize Confidence value to a 10 scale
    Set Entity Confidence metric to confidence value
Goto next Entity
```

Thus, an example of a very simple heuristic algorithm the confidence engine uses to compute confidence in a particular metric would be as follows. Suppose that confidence level is determined by three user-specified variables: Comprehensiveness, Value Chain Importance, and Recency. Each of these variables is assigned a value from 0 to 3. For Comprehensiveness, a 0 is assigned if entity type is unknown; a 1 is assigned if the entity type is known, but not the entity's basic characteristics; 2 if basic characteristics are known, but not additional configuration information, 3 if we have comprehensive configuration information about the asset. Similarly, for Value Chain Importance, 0 is assigned if the asset does not belong to a key value chain but a 3 is assigned if the asset belongs to a mission critical value chain. Finally, a value of 0 is assigned to Recency if nothing has been heard about the asset for more than 30 days, or a 3 if the information is as recent as the current day. The system would then calculate the confidence as the sum of the 3 metrics—normalized to a 0-10 scale.

The fourth primary component of the system is the social discovery engine (SDE) 90, which scans the EMDB, identifies low confidence entities, generates questions, creates and manages conversations with the users to update entities. Confidence engine 70 shown in FIG. 7 triggers SDE 90 to generate user messages 74 based on its confidence values to improve the confidence values for any entities. Responses to the questions are treated like another data source and fed to correlation engine 62 as shown in FIG. 6. The SDE triages and discovers information through the social network within an enterprise by generating queries to human users using various electronic messaging technology formats, and managing redirects from users incident to the human interface conversations. From these queries, the SDE extracts entity data and builds relationships between entities based on inference mechanisms. The SDE triages data discovery tasks based on the entity's confidence value, which reflects in part the importance of the data. An algorithm used to triage queries using confidence value is given below:

```
Order Entities in order of Confidence metric from lowest to highest
For each entity starting with lowest confidence value
    Check if entity belongs to a hierarchy and skip if not in any hierarchy
Determine if an owner exists for the entity
    If no owner assigned, check if owner assigned to hiearchy
    If no owner found, skip entity
    Check if owner is contactable, else skip
    Check if owner already has outstanding requests pending, else skip
    Scan list of entity property confidence weights
    Generate a task to ask owner for missing property with highest weight
Goto next entity
```

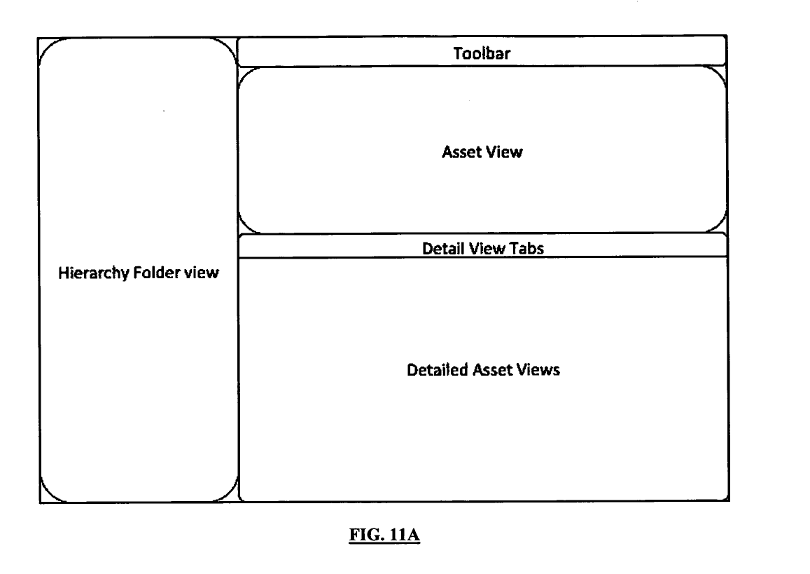

Returning to FIG. 8, the system first determines who the owners of the desired information are, 84. To accomplish this initially, information requests are sent 85 to users throughout the organization. Referring to FIG. 9, which shows the process in more detail, these information requests are generated by components of the SDE 90, namely, question scripting engine 91, conversation management engine 92, and social computing engine, 93. Question scripting engine 91, creates conversation templates to query users about specific information needs. Conversation templates represent an ever growing database of questions that SDE 90 generates to obtain the information that it needs to improve confidence and reliability metrics on the data it stores in the EMDB. The conversation management engine 92 correlates the answers sent by users throughout the organization. Conversation management engine 92 also stores data regarding the human-SDE interface itself; that is, over time as it communicates with users throughout the organization, it determines the best means of communicating with a particular user and recognizes any constraints on the dialogue (such as the maximum number of messages/queries the system can send to this user per day). Queries can be sent by a variety of methods, including but not restricted to instant messages via public and internal messaging systems such as Yahoo/AOL, SMS, electronic mail, short message system (SMS)/text message, or a voice mail/messaging system. A social computing engine 93 uses a variety of protocols (described above, including instant messaging, text messaging, email, voicemails, etc.) to carry on “conversations” with the users. The user responds with a variety of answers, which may include “I don't know”. If the system receives an “I don't know” response, it will generate a follow-on query as to who would have this information. Over a period of time, the system learns which user “owns” each asset within the system; that is, which user to query for information that the system can use to maintain the optimum system configuration and update the EMDB. Every response the conversation management engine receives is stored in an audit database 94. The audit trail database contains the raw material from which correlation engine 62 correlates users with particular assets within the system and builds EMDB 30. The data stored in the audit trail database can be used to update current configuration data in EMDB, 30. The EMDB 30 represents the current state of the IT ecosystem and is optimized for quick search and analytics. Storing raw user response data in audit database 94 separate from the EMDB allows IT managers to track changes and, if necessary, to quickly revert to a previous system configuration.

If any of these computed metrics fall below set confidence or reliability parameters (as determined by management personnel's evaluation of business goals of the organization, and in particular specific value chains [i.e. CRM]), confidence engine 70, in conjunction with SDE 90, will automatically generate informational requests 83 in an attempt to update system asset parameters by first locating the users or data repositories throughout the organization who possess relevant information and then requesting information from these users via manual inputs or via data imports from the repositories. Thus, confidence engine 62 in the course of computing confidence values is able to autonomously identify missing information and generate requests to the appropriate user or data repository to seek this missing information.

An example of the interaction of one particular embodiment of the correlation engine and the SDE follows. The correlation engine 62 monitors a packet moving from Server A to Server B and needs to generate a relationship between the two. To do so, in conjunction with the SDE 90, it generates a query (i.e. an email) to the Systems Administrator Server of Server A, Joe, and asks him about the packet and the relationship between Server A and Server B. Joe does not have the information, but answers the email by referring the question to Bill. A subsequent follow-on query email to Bill yields the desired information on the relationship. The correlation engine then stores this information, along with the information that Bill (not Joe) is the appropriate person to query regarding this relationship. It will also note that email is an effective method of communicating with Joe and Bill and store this information in the EMDB. In this way, the system not only learns information regarding the relationship, but it makes the information gathering process itself more efficient by processing and storing the data on who and how to query to gather information on a desired relationship in the future.

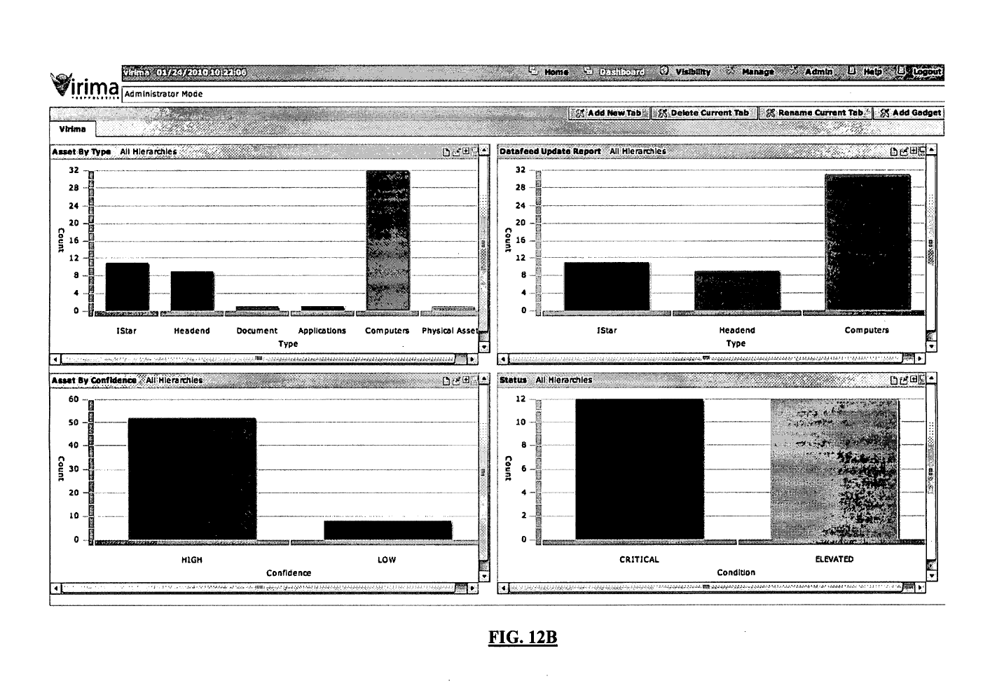

As the system maintains data on the state of the IT ecosystem, it generates a graphical interface where information obtained through user queries can be viewed in a dashboard format by other users in association with the related assets, as shown in FIG. 12. That is, one of the functions of the system is to update the EMDB with a map of not only the physical assets, personnel responsible for these assets and the users who depend on the IT ecosystem, but the relationships between the different entities. Data consistency is maintained though an ongoing conversation with the owners of various assets throughout the IT ecosystem, and uses input from these owners to update the EMDB and also to provide near real time information on the various systems in the IT ecosystem to assist in maintenance, compliance, and routine operational control. Further, autonomic social computing and the IT-BOA platform can be used to maintain, load, or update other CMDBs or data repositories within an enterprise IT organization.

The following is an illustrative example of a preferred embodiment of the application as applied to a hypothetical medium-sized IT organization with over 1500 servers and several thousand other components. In this organization, there are configuration and structural changes that occur on a daily basis, in addition to unplanned incidents that also occur on a daily basis. In addition, the organization has a variety of compliance requirements. First, it needs to track multiple vendor contracts, each with its own service level agreement (SLA). It may also need to comply with a variety of regulatory, accounting, financial, and information security controls and regulations.

The IT organization maintains a legacy CMDB, primarily in order to comply with the information technology infrastructure library (ITIL) standards. Analyst A, who periodically updates the CMDB, is responsible for tracking down the information required to keep the CMDB current. However, the organization's Chief Information Officer (CIO) does not trust the CMDB to provide the kind of information he needs, so he typically consults a number of middle-managers who track down the needed information for the CIO. The CIO's requests often are unfulfilled or delayed, either because the query is sent to the wrong person (which often occurs when information is dispersed widely throughout the organization) or because it takes time to get a response back. The SAP systems administrator, for instance, can provide configuration information, but does not know who the vendors for the servers are, or who the contacts for the vendor data are. Compounding the problem is the fact that the CIO's request may be relatively low priority in light of other demands on the SAP administrator's time, and so the CIO's request may go unanswered for a period of time. Although delays of this type are unacceptable, they are also unavoidable because of the complexity of the system and the dispersion of the relevant information throughout the organization.

One envisioned embodiment of the system would solve this problem by taking advantage of the fact that short requests for information via SMS or personal display system emails are typically answered quickly. The IT-BOA application is set up initially by linking the correlation engine 62 to the organization's key data feeds via data load process 60 and the key contributors to the IT infrastructure and their contact information is also entered into EMDB 30. Analyst A assists the initial setup and configuration of the system by creating an initial value chain/functional hierarchy, which is also stored in EMDB 30. When the system is initially brought online, confidence engine 70 is set up with standard confidence metrics and it identifies IP addresses from the first active port scan (using such tools as NMAP) feed that it cannot trace. In an attempt to identify this unknown IP addresses, the question scripting engine 91, conversation management engine 92, and social computing engine 93 (See FIG. 9) work together to generate a series of queries (“conversations”) to key users in the organization, store user responses 74 in audit trail database 94, and generate follow-on queries. For example, social computing engine 93 sends an SMS message to user A, requesting the nature of the particular IP feed (for example 10.50.1.1). A doesn't know, so he responds to the SMS query from the social computing engine with a suggestion to ask “Jane” another member of the organization. The social computing engine then asks A, via SMS, about another distinct IP address (for example 10.50.1.3). A responds that for the range of IP addresses from 10.50.1.1 to 10.50.1.20, that Jane is the key person.

The social computing engine then looks up Jane in the contact database that was loaded into the EMDB during initialization and finds several “Janes”. A query is sent (again, via SMS, or another appropriate means) to A asking which Jane is the key person. Upon receiving the answer “Jane Smith”, the correlation engine 62 creates an ownership link between Jane Smith and the range of IP addresses mentioned previously. SDE 90 then contacts Jane Smith and conducts a conversation with her via SMS messaging, email, or other appropriate means, and from its conversation learns that the IP addresses in question relate to database servers.

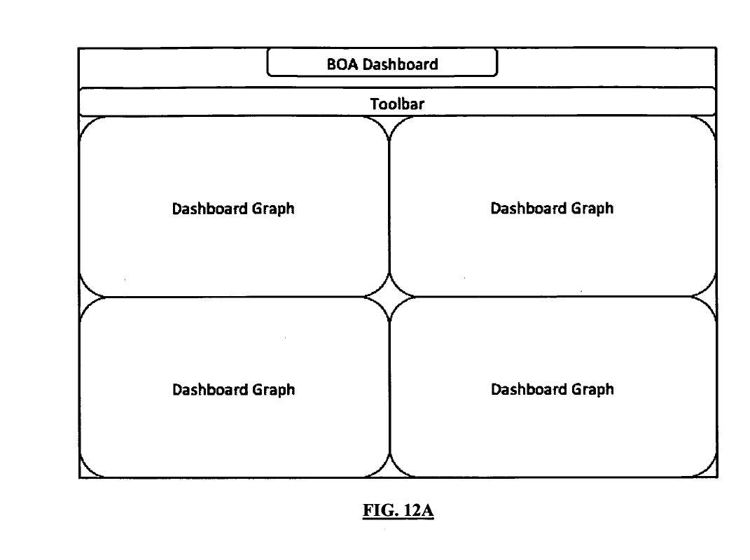

The CIO then decides to query the system to determine the status of, for example, the data repositories in the SAP value chain. The CIO selects the Data Repositories node using the graphical user interface dashboard and increases the Data Repositories' priority relative to the other nodes. A typical user interface shown in FIG. 11. Confidence engine 70 recognizes the higher priority and the fact that the CIO is a key executive and, as a result, updates its confidence computing algorithms so that they aggressively pursue information about the assets in the Data Repository node. This means that and SDE 90 will generate and send out more queries to users seeking this data. If there is a management-mandated limit on the number of queries SDE 90 is allowed to ask of users, queries relating to the Data Repository will take precedence. Within a relatively short period (for example, within 48 hours), the CIO can view data that the application has been collecting, which includes information on the Data Repositories and who the system has queried for information, including users who have not responded to the and SDE's queries.

The CIO finds out that the SLA's for the node have not been filled out, so using the user interface shown in FIG. 11, he can go to the SLA tab and make an update request. The application, using the correlation engine 62 examines the node and notes that most of the assets under the node have been updated by user Jane, so it sends its first query to her. Jane replies that the SDE should ask someone from the SAP Center of Excellence. From this exchange, the application learns that the SLA information required by the CIO for this node does not come from Jane, so it generates a query (or series of queries) to users from the SAP Center of Excellence. It has also learned that the CIO has placed a priority on SLA information, and updates its monitoring algorithms accordingly. As the application continues its conversations, it learns over a period of time who the key users are within the system and, based on the quality of their responses to queries, builds a database of key users and the information they can provide. As a result, as the system finds anomalies, it can request updating information quickly from users who have only the relevant information. Users can query the system for information they need using both fixed and mobile computing devices (such as SMS and email) and quickly receive an answer from the system, which, if it doesn't already have the information, knows exactly which users to query to obtain the information. The end result is a system where information on the IT ecosystem within an organization is quickly available, and users are not inundated with requests that they cannot answer. This example has illustrated that one of the objectives of the invention is to increase the efficiency of information requests between members of the IT organization.

This social computing paradigm facilitates the management and execution of policies for the entire IT ecosystem by what is considered the governance module of the application. The governance module uses semantic recognition software in data load process 60 to import policies from a governing document 68 into the system. See FIG. 6. The governance module interfaces with the EMDB to obtain the organizational hierarchy from a higher level to a subordinate/individual level. This hierarchy may be defined by value chains/functional groups within the business organization as well as by formal organizational structure. After importing the policies from the governing document, the governance module breaks up general policies into smaller discrete sections of policy. It then assigns discrete sections of policy to the appropriate level of the hierarchy. The system imports the policy in the form of a document, organized in a hierarchical manner, and breaks up the general policy into a number of discrete components. Each of these components is then assigned to the appropriate entities. These assignments are governed by the organizational map stored in the EMDB. The system's breakup of the policy and subsequent assignments are typically subjected to end-user (i.e. IT management) review, and modifications to these discretizations and assignments can be made based on this feedback. In doing so, the system executes a process which selects and assigns all or part of an overall policy to particular levels in the hierarchy. Once policies have been assigned, the system provides feedback on policy compliance to all levels of the hierarchy through top-down, bottom-up, and sideways feedback.

For example, top-level management at the Chief Technology/Information Officer level may set a particular policy. Lower level manager and personnel note that the policy has been associated with their particular business process, feeds, assets, controls, and profiles and that they are tasked with implementing the policy. Each lower-level manager then manually reviews the policy and may accept the entire policy, if appropriate, or alternatively only those sections that are relevant to his/her particular business function. Managers or personnel on lower level then review the change that the higher-level manager has proposed/selected and either accept the higher level manager's refinement, or propose additional refinements. The entire process of updating, editing, and refining policies uses social computing concepts based on the wiki technology model. The wiki technology model is a social computing concept based on the Wikipedia model, where users throughout the community are free to edit and modify information in a collaborative effort characterized by peer review and modification.

The system also executes a process of measuring, capturing, structuring, and viewing/reporting on IT business metrics. This process consists of capturing and aggregating data from different sources in the IT ecosystem. The system then transforms and translates the data into usable and measurable metrics. It also organizes the assets comprising the overall IT infrastructure and identifies the relevant data and computed metrics. The information can then be organized in multiple hierarchical organizations to facilitate emulation of a matrix organization. These metrics and data history are stored in a database. Users are allowed to view data transformation over time and across different parameters to allow users to recover from harmful or undesirable actions. The system allows users to simulate possible outcomes using what-if scenario analysis. The system further allows for reconciliation and adjustment of metrics and data based on user feedback. Finally, the system allows for the creation of thresholds to facilitate compliance with governance policies that are dictated by company internal policy, as well as all applicable laws and regulations that the company is required to comply with.

An example of this embodiment would be if 100 assets within an organization were scanned by a network monitoring tool and operating statistics were provided through server monitoring and configuration software. Data from these applications become an input for the system, which transforms this data into information that is useful and actionable. This is accomplished when the system aggregates this data over time and is able to present to the user trends for a selected group of parameters that are relevant to a particular organizational policy for an aggregation of assets over time. This allows IT managers to quickly spot, for instance, that there is a lapse, violation, or breakdown of IT policies within the organization.

A final aspect of the system involves the computation of metrics which allow an organization to create new knowledge from existing data that has been collected from the IT ecosystem. There are three general categories of metrics which can be computed: user confidence, performance metric risk, and additional relationships.

User confidence is calculated based on the acceptance or rejection of user responses to queries by others within the organization. That is, user confidence is based in some instances on peer review of user responses, or by comparison of a given user's response with responses from other users. Some questions can only be answered by one person; in this case, the person's response may be overridden by a manager. The user confidence metric that is calculated can then be used to further query the user and establish virtual centers of excellence within the organization in an organic fashion rather than simply mandating an organizational structure.

Performance metric risk is a parameter derived from the confidence level about a variety of the organization's performance metrics. Current systems known to the art may calculate whether the IT assets within the organization are meeting the performance parameters set forth in an SLA. The applicants' system performance management module proactively queries asset managers to determine the assets within each value chain that are critical to meeting these performance parameters. From these managers' responses regarding at-risk assets, it will both determine the quantitative probability of meeting these performance parameters and identify the assets that are critical to meeting the performance parameters. Additional relationships refer to associations that are not evident from the organization's formal structure, nor from automated data sources, and which are verified and validated through human intelligence.

To illustrate, the medium-sized IT organization used above will once again be used to demonstrate an embodiment and application of the invention. As mentioned above, in this organization before the system described herein was implemented, IT configuration information was widely spread throughout the organization and IT managers and users used a number of informal channels to obtain the information they need. These informal channels relied on word of mouth regarding who has certain information, how reliable the information was, etc. “Information” in this context can be either basic (such as which operating system is used in a particular server) or more global (such as the SLA's that apply to a particular task).

In addition, the organization also tracked a number of performance metrics such as availability and security. Availability in this example refers to customer availability of the customer relations management (CRM) system, which is defined by the SLA as the percentage of times that any user in any office will be unable to access the system for any reason whatsoever. The organization's security metric is defined as the number of high and medium vulnerabilities per device. The customer has manual mechanisms in place to measure these metrics and the measurements are done quarterly. It is extremely important to meet the goals specified for these metrics, and that corrective action is taken immediately if these goals are not being met. The organization's success depends on 1) understanding all parameters and relationships that affect the performance metrics; 2) proactively finding early warning signs that could cause issues, and 3) finding the appropriate sources of information.

As an example, we assume that the system has been initialized as described above and has been running for a number of months. During a particular month, it is noticed that the availability metric has dropped to 98%. This is cause for concern because of the SLA, and would normally be the subject of multiple meetings. However, in lieu of meetings, the performance management module detects the anomaly, and automatically generates messages to various users throughout the system that the system's algorithm has determined possess the relevant information to correct the anomaly. One of the messages from “K”, an infrastructure engineer, indicates that his disk drives have been failing with greater frequency. K is noted by the system as being a source for disk drive availability information (a “high confidence user”). Taking this message, the system searches for “disk drives” using an intelligent search which involves searching not only key words, but also contextual information regarding disk drives. Once the disk drives are found, the system takes note of the drives in the value chain that have broken down. It also sends a message to the value chain administrator asking whether disk availability should be added to the availability metric for the value chain. Once this performance metric is updated, the performance management module computes the “metric risk”, defined as the probability of failing on the metric during a given month. The performance metric module also provides a list of potential fixes to reduce the metric risk. This list contains the assets that are most critical to maintaining the given performance metric. During a meeting to discuss SLA non-compliance, all of the users attending the meeting should have access to all the relevant information from the performance management module—reasons, potential fixes, and forward-looking risk computation—that will enable them to address the problem. The performance management module, now noting the priority placed on this metric, will periodically send out messages to various value chain participants regarding concerns users have about meeting specific performance metric goals, and analyzes the responses given in a manner similar to what has been described. During this process, the performance management module has created new relationships (i.e. the relationship of disk drives to the SLA-mandated availability metric), calculated the likelihood of not meeting performance metrics, suggested likely ways to reduce this likelihood, and continued to build and update its relational database linking individual users with particular parts of information.

Another application of the preferred embodiment is managing enterprise-wide information technology policies, such as an information security policy. This application is particularly useful when attempting to manage policies imposed by either private or public regulation, such as banking and financial regulations, Payment Card Industry (PCI) standards, or Sarbanes-Oxley regulations; or contractual obligations. Broad policies relate to the entire enterprise; however, sub-parts of this policy must be applied to specific subsets of the enterprise. This application of the preferred embodiment, then, involves defining an organization in a hierarchical manner, breaking down a broad policy into sub-parts that are applicable to specific entities within the enterprise, and assigning these sub-parts to the applicable entity. Users within the organization are then queried for their feedback in order to refine whether or not such assignments of sub-parts are appropriate. In this way, a broad information technology policy can be implemented relatively quickly, and user feedback ensures that the policy is applied correctly at all levels within the organization.

In practice, the first step is to model the information technology ecosystem within EMDB 30. The initialization process includes interfacing with all of the hardware components within the enterprise and begins loading the properties of each component based on the blueprint of desired properties to be monitored. Once loading is complete, the entities within the IT ecosystem are assigned to a hierarchical structure by correlation engine 62 using rules provided by IT managers. The hierarchical structure itself is developed using correlation engine in conjunction with SDE 90, and these two components also update entity relationships.

The policy document itself 68, upon being loaded by the correlation engine 62, contains both rules of applicability and rules of conformance. The policy itself also contains a rule of priority, namely, whether it takes precedence over other policies. These rules become their own unique entities within EMDB 30, that like other entities are assigned to the hierarchical structure. Any given policy entity may apply to either single or multiple levels of the hierarchy. At any given level in the hierarchy, policy entities applying to that level as well as all higher levels are analyzed and merged using pre-defined priorities generated by the owners of a given value chain or functional group. The end result of the analysis and merge is a final policy that is tailored to each entity at a given hierarchy level.

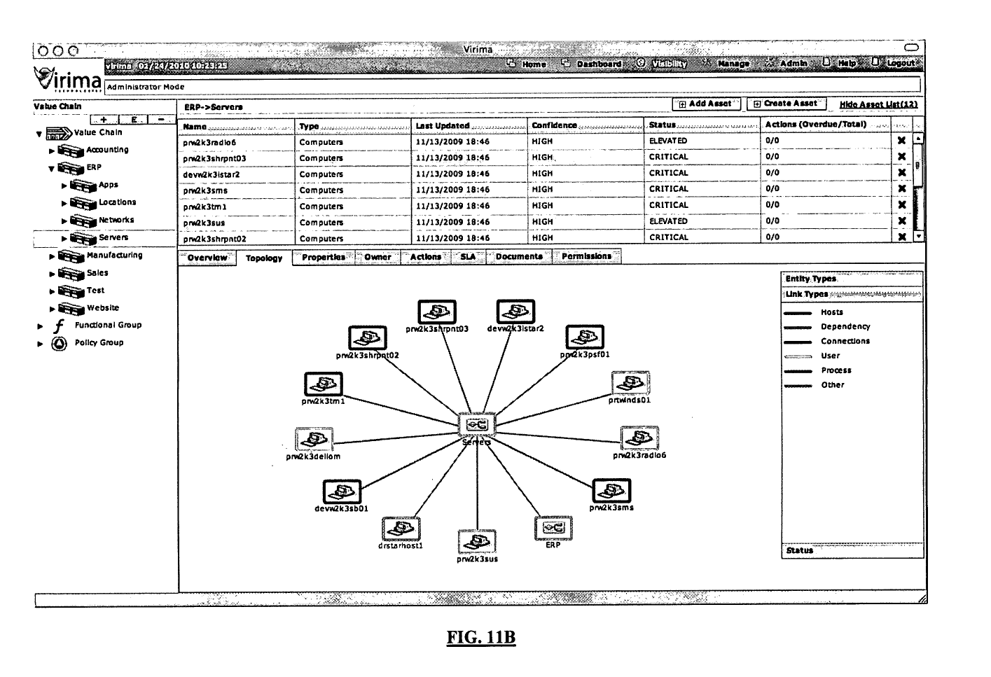

The system's ability to import, analyze, and assign policies to entities within the enterprise facilitates audits of information technology systems, where compliance with specific thresholds of performance, safeguards, operational consistency, etc. are evaluated. As shown in FIG. 10, a request from auditor 1001 prompts identification of the relevant entities in the system, 1002. An initial batch of data on system state is provided from the EMDB, and the SDE 90 is initialized to capture more data from users 1003. Confidence values and blueprints are set according to requests for specific information by the auditor 1004. Manual audit evidence then generated, which can then be provided to the auditor, 1006. The confidence engine is also updated with new confidence values, 1005.

Ongoing post-audit monitoring then proceeds as a recursive process, as shown in FIG. 10. Audit entities have discrepancy thresholds reviewed periodically 1007. Correlation engine 62 identifies new entities, determines when discrepancies from given standards occur, or when trends indicate that a discrepancy is likely to occur in the near future 1008. Confidence levels and data audit standards are maintained, 1009, by having SDE execute queries to users within the enterprise based in part on confidence values generated by the confidence engine. The data received from users in this process is then captured and used to update EMDB 30.

The embodiments described above are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. A computer-implemented data processing system for automating enterprise-wide information technology configuration management comprising:
A database,
A confidence engine,
A social discovery engine, and
A correlation engine
Wherein said database stores entity information, said correlation engine processes said entity information, said confidence engine calculates one or more confidence values for said entities, said metrics being stored in said database, and said social discovery engine autonomously generates user queries requesting said entity information.

2. The data processing system of claim 1, wherein said database is a configuration management database.

3. The data processing system of claim 1, wherein said user queries are generated based on said confidence values and pre-determined query protocols

4. The data processing system of claim 1, wherein said user queries are instant messages

5. The data processing system of claim 1, wherein said user queries are electronic mail messages

6. The data processing system of claim 1, wherein said user queries are short messaging system messages.

7. A method of generating a visual configuration management report for a user regarding whether two or more information technology entities and one or more of their corresponding properties are related, comprising the steps of:
Receiving from the user desired attributes of interest on two or more entities;
Capturing data on said two or more entities regarding said attributes from one or more databases using a first set of machine-executable instructions;
Comparing said data with said attributes using a second set of machine-executable instructions;
Calculating at least one confidence value based on the results of said comparison using a third set of machine-executable instructions;
Generating one or more user queries using a fourth set of machine-executable instructions;
Updating said data based on responses received from said user queries using said first and second set of machine-executable instructions; and
Generating a user report using one or more user input/output devices.

8. The method of claim 7, wherein said user queries are generated based on said confidence values and at least one pre-determined query protocol.

9. The method of claim 7, wherein said user queries are in the form of instant messages.

10. The method of claim 7, wherein said user queries are in the form of electronic mail messages.

11. The method of claim 7, wherein said user queries are in the form of short messaging system (SMS) messages.

12. The method of claim 7, wherein said user report is an audit report.

13. A computer-implemented method of automating enterprise-wide information technology configuration management, comprising the steps of:
Processing raw data relating to a plurality of entities from a plurality of inputs, wherein said processing includes the step of deriving or inferring relationships between said entities using a first set of machine-executable instructions;
Generating relationship data based on said relationships;
Loading said raw data and said relationship data into a database using said first set of machine-executable instructions, wherein said raw data and said relationship data comprise entity data;
Scanning said entity data on a predetermined schedule using a second set of machine-executable instructions;
Calculating a confidence value for each said entity, using said entity data and said second set of machine-executable instructions;
Generating one or more information request messages to users based on said confidence value in relation to a pre-defined threshold value using a third set of machine-executable instructions;
Updating said entity data with data received from responses to said information request messages; and
Generating a configuration management report using one or more user input/output devices.

14. The computer-implemented method of claim 12, wherein said information request messages are generated when said confidence value is less than a pre-defined confidence value.

15. The computer-implemented method of claim 12, wherein said information request messages are in the form of instant messages.

16. The computer-implemented method of claim 12, wherein said information request messages are in the form of electronic mail messages.

17. The computer-implemented method of claim 12, wherein said information request messages are in the form of short message system (SMS) messages.

18. A computer-implemented method of managing and executing information technology policies for an enterprise, comprising the steps of:
Creating a hierarchy of policy groups in the memory of one or more databases;
Importing a policy document into said memory of one or more databases;
Processing said policy document into discrete policy segments using a first set of machine-executable instructions;
Storing said discrete policy segments in said memory of said one or more databases;
Assigning said discrete policy segments to said hierarchy using one or more user inputs and said first set of machine-executable instructions;
Associating said policy segments to one or more entities stored in said one or more databases, using a second set of machine-executable instructions;
Accepting feedback from users relating to said policy segments using a third set of machine-executable instructions;
Updating said one or more databases based on said feedback using said third set of machine-executable instructions.
